(19) United States
(12) Patent Application Publication
(10) Pub. No.: US 2017/0018281 A1
(43) Pub. Date: Jan. 19, 2017

(54) METHOD AND DEVICE FOR HELPING TO UNDERSTAND AN AUDITORY SENSORY MESSAGE BY TRANSFORMING IT INTO A VISUAL MESSAGE

(71) Applicant: Patrick COSSON, Pully (CH)

(72) Inventor: Patrick COSSON, Pully (CH)

(21) Appl. No.: 14/829,763

(22) Filed: Aug. 19, 2015

(30) Foreign Application Priority Data
Jul. 15, 2015 (CH) 01030/15

(51) Int. Cl. G10L 21/10; G02B 27/01; G06F 3/01; G09B 21/00; G10L 15/26; G06F 17/28

(52) U.S. Cl. CPC G10L 21/10; G10L 15/26; G06F 17/289; G06F 3/013; G09B 21/009; G02B 27/0176; G02B 2027/0178

(57) ABSTRACT

A method and a device for helping a hearing-impaired person to understand an auditory sensory message by transforming the auditory message into a visual message and projecting this message on a support in the field of vision of the hearing-impaired person. This device comprises a support (11) carrying a sensor in the form of microphones (16, 17) to pick up the message, recording and memorizing module (19) for recording and memorizing/storing in real time the auditory message, and transforming the message into a visual message. A screen (18) is placed in the field of vision of the user, and at least one projector (20, 21) projects the visual message on the screen. A sensor detects pupil movement of the user and mechanism converts pupil movement of the user into a display command for the visual message, and carrying out the command by projecting the visual message.

This application claims priority from Swiss Application Serial No. 01030/15 filed on Jul. 15, 2015

### TECHNICAL SCOPE

This invention relates to a method for helping in particular a hearing-impaired person to understand an auditory sensory message by transforming said auditory sensory message into a visual message and projecting it on a surface positioned in the field of vision of said hearing-impaired person.

It also relates to a device implementing the method for helping in particular a hearing-impaired person to understand an auditory sensory message, including means for transforming said auditory sensory message into a visual message and means for projecting it on a surface positioned in the field of vision of said hearing-impaired person.

### PRIOR ART

In certain situations, a person may have difficulty in perceiving an auditory message, making its comprehension impossible or uncertain. The problem is generally due to a physical defect such as for example first signs of deafness linked to ageing or to an accident or a disease, often manifested by decreased sensitivity of the ear to certain frequencies. A prescription of a hearing aid by a specialist in order to amplify the sound so as to facilitate the perception of the message is often considered as the remedy for this comprehension failure. But the amplification of the sound volume does not solve all problems, in particular when one of the problems is linked, for the concerned person, with the selective loss of certain hearing frequency ranges. Sound amplification does not allow re-creating the missing frequencies. Moreover, the uncertain comprehension mentioned above is not perceived as such by the person, nor by the interlocutor, and may lead to interpretation errors with more or less troublesome consequences.

Most of the current hearing devices that are recommended or prescribed to overcome these drawbacks are ineffective and are therefore often abandoned by the user who does not find in them the answer to his problem. In particular the fatigue caused by the excessive concentration required when using these hearing aids leads to an additional risk of faulty comprehension.

The situations are manifold, but some can be distinguished:
a person with a more or less strong hypoacousia that can go up to total deafness;
a person perceiving an auditory message lost in a disturbing sound atmosphere, for example at a working place in a loud industrial environment or in an open collective environment;
a person who does not master sufficiently the language of his interlocutor may not isolate properly its phonemes and be unable to recognize the pronounced words.

All these situations make the concerned person uncomfortable, which results in the inability to answer or to take part in a conversation because of incomprehension.

The only alternative is then to ask the interlocutor to repeat what he said, sometimes several times, with a still remaining risk of misunderstanding, which becomes increasingly embarrassing for the person who is to answer. The interlocutor may also tire and abandon the conversation. The hearing-impaired or “comprehension-impaired” person feels even more uncomfortable in this situation and can quickly tend towards isolation or content himself with partial understanding, which sometimes leads to serious and harmful consequences.

If the problem is a more or less important deafness, there are hearing aids acting as sound amplifiers on the whole pass band or more specifically on certain deficient frequencies according to the type of deafness. The benefit offered by these devices is variable, or even uncertain. The increase of the intensity of the sound information is more or less global, with the drawback of increasing both the relevant information and the background noise, even though certain devices try to correct this with more or less success. So, auditory fatigue is high in a very loud environment, especially when several interlocutors speak at the same time. One should not forget that the hearing-impaired person is not used any more to this background noise and is suddenly solicited, with these devices, by a very noisy environment that forces him to be extremely vigilant to extract the relevant information. Often the hearing-impaired persons, who cannot bear this auditory fatigue, abandon their hearing aid and take refuge in a more comfortable silence, at the cost of progressive social isolation. Their habit of this isolation is less disturbing to them than the auditory fatigue or the possible feeling of shame and guilt caused by uncertain comprehension.

Some equipment uses nervous stimulation techniques instead of acoustic stimulation. As an example, osteology, which ensures vibration transmission through the bone itself or direct cochlear implantation. Apart from the fact that these are invasive and traumatic techniques, they have the disadvantage of replacing the natural sound information with sensory information of an unknown type and therefore impose a long orthophonic training that may sometimes require over a year for a substitution efficiency that often remains partial and very far from natural auditory perception. Many hearing-impaired persons refuse these techniques.

Most of the existing techniques offer to try to improve the perception of the sound information by means of sound amplification or of the use of a non-natural sensitiveness, both being disturbing for the concerned person. But the problem posed is not so much the perception of the information than the intellectual comprehension of this information.

In this regard, the American U.S. Pat. No. 5,475,798 describes a comprehension aid that allows transcribing a vocal information into a written information and displaying said written information on a display arranged in the field of vision of the user. The different proposed embodiment variants of the device are relatively bulky and do not allow initiating the display of the written information in an automatic way, on a simple request of the user, which makes its use complicated and reduces the ease of use of said device, as does, on the other hand, its size. This device must obligatorily be started manually by the user before it can be used. But the hearing-impaired person does not know when he will need a comprehension aid, as this might involve a simple word not understood in a phrase said by an interlocutor or a partial incomprehension during a discussion or a conference. The device must imperatively be permanently available, and the user must have the possibility to re-listen or transcribe the data, even after a first display.

### DESCRIPTION OF THE INVENTION

This invention proposes a solution for these problems by offering a simplified device, that is easy to use, allowing the user to have a visual information that translates a wrongly perceived or wrongly interpreted vocal information, this transcription or translation taking place in an almost automatic way, discreet with respect to the environment, without specific intervention and offering complementary applications such as supplying help for the comprehension of foreign languages or languages poorly mastered by the user. Finally, the variety of problems that may arise, such as the bad translation of a language, the wrong understanding of a word or expression, requires a versatile equipment that is immediately available, discreet and reliable, the whole being concentrated on a device that combines all functions.

To that purpose, the method according to the invention is characterized in that one picks up said auditory sensory message by means of at least one sensor mounted on a support of the spectacles type or equivalent, in that one transforms said auditory sensory message into a visual message, in that one records said auditory message, in that one projects said visual message following a user command on a screen integral with said support of the spectacles type or equivalent, placed in the field of vision of said user, in that said user command is carried out by at least one pupil movement of the user and in that the projection of the visual message is performed in a static or scrolling way, one single time or repeatedly, immediately or with a delay, depending on said user command that is picked up by a member detecting said pupil movement.

The projection of the visual message is preferably carried out on at least two display lines, the first line being assigned to the display of the visual transcription of the auditory message, the second line being assigned to additional information useful for the comprehension of said message.

Said additional information useful for the comprehension of said message can be a translation of said auditory message into a language chosen by the user.

The projection of the visual message can advantageously be carried out with a predetermined lag with respect to the communication of said auditory message.

The device according to the invention is moreover characterized in that it comprises:

a support arranged to carry the set of functional elements involved in the fulfillment of the functions of the method, said set of functional elements comprising:

at least one sensor arranged to pick up said auditory sensory message and mounted on said support,
recording and memorizing means to record and memorize in real time said auditory message, transformation means to transform said auditory sensory message into a visual message,
a screen integral with said support and placed in the field of vision of said user,
at least one element to project said visual message on said screen of the spectacles type or equivalent,
at least one sensor of a pupil movement of the user,
means for converting a pupil movement of the user into a display command for said visual message, and
means for carrying out said command by projecting said visual message in a static or scrolling way, one single time or repeatedly, immediately or with a delay.

Said support is advantageously of the spectacles type or equivalent and includes a front bar with a bridge, said front bar carrying two temples articulated at the ends of said front bar.

According to a preferred embodiment, said element to project said visual message includes two projectors respectively mounted on said temples, each of said projectors being arranged so as to project at least a part of said visual message corresponding to said auditory sensory message.

According to the preferred embodiment, the device comprises means for picking up at least one pupil movement of the user, means for interpreting said at least one pupil movement and means for carrying out a command for projecting said visual message according to the interpretation of said pupil movement.

Said means for carrying out a command for projecting said visual message can be directly coupled with said projectors arranged to project at least a part of said visual message.

Said at least one sensor arranged for picking up said auditory sensory message is advantageously a directional microphone mounted on the front section of said support.

According to a preferred embodiment, the device includes an electronic unit powered by an electrical power source, said electronic circuit comprising a first module called memorization module that is arranged to memorize temporarily and in real time the auditory sensory message, a second module called transcription module arranged to transcribe the auditory message into visual data, a third module called control module that is arranged for receiving and interpreting the pupillary command message and working out the corresponding visual message, and a fourth module called display triggering module, arranged for carrying out the display of the message according to the pupillary command.

Advantageously, at least one of said first module called memorization module, second module called transcription module, third module called control module and fourth module called display triggering module of said electronic circuit is arranged remotely from the support of the device and comprises means for transmitting and receiving information to and

The device preferably comprises a display device mounted on said front bar arranged for displaying said visual message in the form of a signal made of words and written phrases and/or of informative acronyms.

This display device can comprise a screen including at least two lines arranged for displaying said visual message in a static or scrolling way, one single time or repeatedly, immediately or with a delay.

This display device can be arranged according to another layout to project said visual message directly on the upper section of the spectacle lenses.

### BRIEF DESCRIPTION OF THE DRAWINGS

The present invention and its advantages will be better revealed in the following description of an embodiment given as a non limiting example, in reference to the drawings in appendix, in which:

FIG. 1 is a schematic global view illustrating all main components of the device according to the invention,

FIG. 2 is a schematic view illustrating the main stages of the process of the invention according to a first embodiment, and

FIG. 3 is a schematic view illustrating the main stages of the process of the invention according to a second embodiment.

### BEST WAYS OF REALIZING THE INVENTION

The device according to the invention comprises several components that allow on the one hand to pick up a vocal information, to transcribe this vocal information into a visual information, on the other hand to display said visual information in the field of vision of an user, on his request, if necessary to scroll the visual information in the predetermined area of said field of vision. The information can be memorized, its display can be static, but preferably moving, and scrolling can be initiated instantaneously or with a lag defined previously, or even repeated, so that the user can access the information at any time when he considers this necessary, according to the level of comprehension of the communicated vocal information.

It is essential that the visual data is put at the disposal of the user in an efficient, quasi automatic and discreet way, so that the user will not be penalized by the handicap of a bad auditory perception or of a wrong comprehension of the vocal message and that he will be able to take part normally in a discussion or even in a debate.

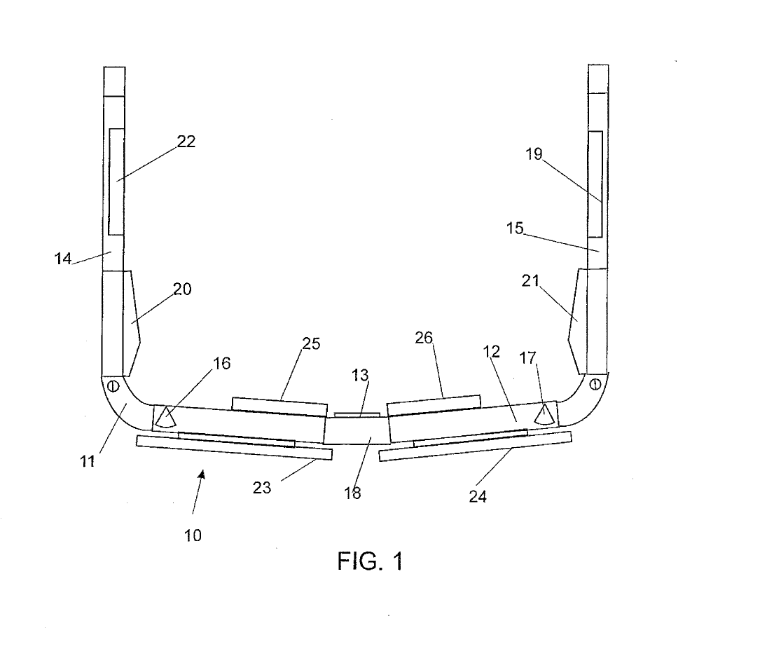

Referring to the figures and especially to FIG. 1, device 10 comprises a support 11 arranged to carry the set of functional elements involved in the fulfillment of the functions mentioned above. Support 11 advantageously consists in a spectacle frame or equivalent in the form of a front bar 12 provided with a bridge 13 and two temples 14 and 15 articulated at the ends of front bar 12. It can also be made of an independent part fixed by quick mounting means on a classical spectacles support. Front bar 12 is arranged in order to be located at the height of the eyebrow line, that is to say higher than the cross member of classical spectacle frames.

Support 11 carries two very directional microphones 16 and 17 that are mounted on either side of bridge 13 of front bar 12 and that pick up preferably the sounds emitted by an interlocutor located in front of the user. Front bar 12 is advantageously arranged at the level of the user's eyebrows and includes in its upper section a rectilinear strip 18 having a height sufficient to allow displaying at least two lines of text, said strip 18 forming a screen on which the visual information that transcribes the vocal information the hearing-impaired user has difficulty to hear and/or to understand is projected.

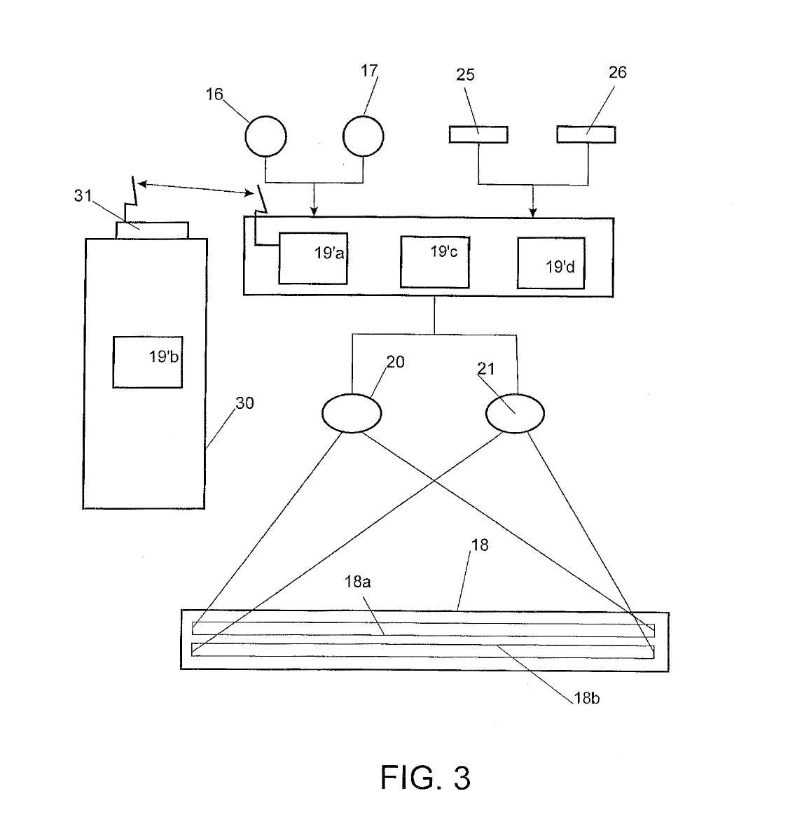

The vocal information picked up is processed by an electronic unit 19 that includes different areas with different functions. In the example represented in FIG. 1, this electronic unit is integrated in one of the temples 15 of support 11. A first module 19a called memorization module memorizes the auditory signal in real time. A second module 19b called transcription module is arranged for transcribing the auditory message into visual data, for example in the form of a signal of words and written phrases that can be scrolling. A third module 19c called command interpretation module prepares the visual message to be displayed according to the command transmitted by pupil movement detectors 25 and 26. A fourth module 19d called display triggering module transmits the visual message to two projectors 20 and 21 and triggers the display of the visual message on front bar 18 or on lenses 23 and 24 of spectacles support 11. Projectors 20, 21 are arranged to project said words and said phrases on said strip 18. When the strip comprises two lines 18a and 18b, one of the lines, for example upper line 18a, displays the communicated information in a scrolling way, while lower line 18b displays additional information useful for the comprehension of the message, this additional information can be for example a translation in a foreign language of the communicated message or the display of informative acronyms. The scrolling display operates substantially like a prompter. The transmission of the signal from said fourth module 19d called display triggering module to projectors 20, 21 can also take place through a wired connection. The fourth module 19d can also transmit the information to a mobile phone or a tablet or any other equipment provided with a display screen 30, as shown in FIG. 3, located remote from support 11, being understood that in this case communication means between the remote components and the integrated components must be provided.

Electronic unit 19 is powered by an electrical power source 22, preferably a rechargeable battery, located for example in temple 14 by means of a wiring integrated in support 11. Front bar 12 also serves as the support for spectacle lenses 23, 24. If the support is carried by a classical spectacle frame, the spectacle lenses can be mounted directly in this frame and support 11 of device 10 then does not carry the spectacle lenses, but only the functional components of device 10.

The mentioned communication with a mobile phone or a tablet or any other equipment provided with a display screen allows transferring the sound signal to a signal processing device integrated in these devices, but also receiving from the latter a return signal in the form of a phrase written in a suitable language or of particular symbols that can be displayed by the display of strip 18.

The first module 19a called memorization module of electronic unit 19 is arranged for memorizing the auditory information, the third module 19c called command interpretation module and the fourth module called display triggering module are arranged for re-using the data memorized in module 19a in order to delay if necessary by a few seconds the display of this information transcribed in written form.

The fourth module 19d called display triggering module is arranged to allow displaying, if necessary by scrolling, the transcribed visual message, delayed or repeated as the case may be, possibly with a translation, on request of the user. The operation is triggered on request of the user by the detection of a predetermined movement of his eyeball by means of at least one pupil movement detector 25, 26 located on the internal side of front bar 12, in front of each eye.

A device management software allows the user to select operating options relating for example to the display of the information transcribed from phonic to visual, such as the selection of the static display mode, the selection of the scrolling display mode, the repetition of an information, the selection of a translation language, the integral transcription of a telephone conversation. The active pupil movement could for example be an upward move with a first meaning that is the command to start a projection, a leftward movement having a second meaning such as the command of a time lag, a rightward movement having a third meaning such as the command of an acceleration of the scrolling, a downward movement having a fourth meaning such as the access to the selection menu of the display options and their validation.

Further possibilities can be developed, such as the one that consists in displaying at least one light signal when perceiving an interlocutor in order to alert the user, the one that consists in a written description of an abnormal sound environment, the one that consists in displaying alarm acronyms for certain sounds, such as for example the ringing of the phone, of a doorbell, an alarm clock, an abnormally high sound level, an approaching vehicle, a crash of glass, metal, a fire, boiling water, flowing water, a thunderstorm, the falling of an object, the noise made by a person, barking, or that of communicating in writing orally transmitted instructions.

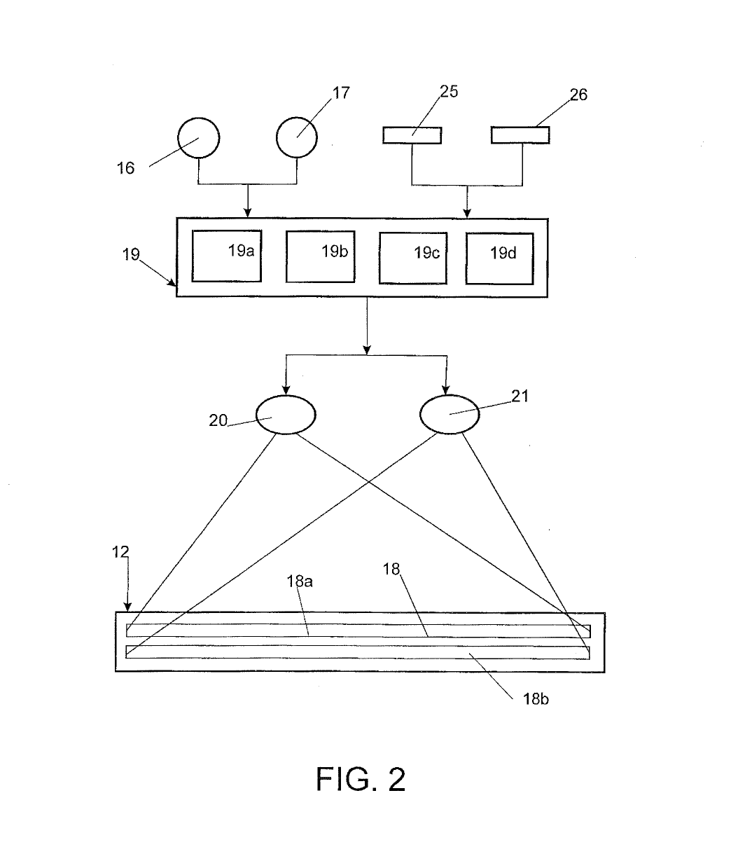

FIG. 2 illustrates the main stages of the operation of device 10 when it is configured according to a first variant. The first stage consists in picking up the auditory

SUBSTITUTE SPECIFICATION sensory message with two very directional microphones 16 and 17 and in sending them into electronic circuit 19, more specifically into first module 19a of this circuit that plays the role of the receiver, powered by an electrical current source 22. The auditory sensory message is transformed into a visual message by module 19b. The connection between microphones 16/17 and the electronic circuit can be ensured by means of a cable mounted in support 11. Module 19c is designed to interpret a control signal transmitted by pupil movement detectors 25, 26. Module 19d, called display triggering module, triggers the display of this message according to the interpretation provided by pupil movement detectors 25, 26. The display can be subdivided into two complementary message elements C1 and C2 by transmission to projectors 20 and 21 that project it on one line 18a or on two lines 18a and 18b of a display carried by display strip 18.

FIG. 3 illustrates the main stages of the operation of device 10 when it is configured according to FIG. 3 that represents a second embodiment variant. The functional components are the same in this embodiment, but a part of the functionalities is relocated in a mobile phone 30 or in a tablet or similar, provided with a transceiver 31, so that the transcription of the message can benefit from additional computer means that improve the abilities of the system to fulfill its comprehension aid function. In this configuration, the electronic module is a module 19′ having the function of a transceiver, arranged for communicating the vocal message of microphones 16 and 17 to the remote element, that is to say to mobile phone 30, via its own transceiver 31. In this case, module 19′ carried by temple 15 of device 10 comprises a module 19′a having the functions of a transceiver, a module 19′c identical to module 19c of the first variant, that is to say the interpretation of the pupil movement, and a module 19′d identical to module 19d of the first variant, that is to say the control of the display.

In the second variant, only the transformation of the vocal message into a visual message and the possible addition of additional data or the transformation of the signals is carried out on equipment external to device 10.

The visual message, which consists in one or two phrases, or the displayed acronym, corresponds to the few last seconds elapsed and registered by the auditory sensor. The user can then make sure that he has heard correctly the sound message, without errors, thus ensuring perfect comprehension, even in the absence of total perception.

This operating mode can be used for situations requiring perfect comprehension, even though there is no perception deficiency. This is the case for a discussion between two persons talking different languages, when the user does not master perfectly the language of his interlocutor. In this case, the first line displays the message in the language of the interlocutor and allows the user to make sure he perceived the right word, and thus to improve his knowledge in this language. He can also use the second line to display the translation of the upper line in his own language, therefore ensuring his good comprehension even if he does not master the concerned language at all.

The device can be used by a person suffering from total or partial deafness for all everyday activities, in particular perceiving alarms or for verbal, telephonic communication; by a person suffering from cognitive impairment, for example dementia or Alzheimer's disease that does not allow understanding the meaning of the sound signal; by a person performing work far away from a signal transmitter or in a noisy environment that does not allow a proper comprehension of a phonic signal.

The device might be used as a prompter, for lecturers, actors, in the theatre, to learn music, one line displaying the score, the second its literal translation or similar.

The invention is not restricted to the described embodiments and can have different aspects within the framework defined by the claims. The realization and layout of the various components could be modified while still respecting the functionalities of the device. The applications could be extended beyond the support for people suffering from total or partial deafness.

In particular, the device can be arranged to be connected through electronic unit 19, for example of the “Bluetooth” transceiver type, with any external device having a suitable connection and to receive an auditory signal to be processed the same way and according to the same procedure as the signal provided by microphones 16 and 17. This variant allows in particular processing visually a telephone communication or a command given remotely on a building site, for example by means of a walkie-talkie or any other auditory or electrical means.

1-15. (canceled)

16. A method for helping a hearing-impaired person called a user to understand an auditory sensory message by transforming the auditory sensory message into a visual message and projecting the visual message on a surface positioned in a field of vision of the user, the method comprising:
picking up the auditory sensory message by at least one sensor mounted on a support of a spectacle or equivalent component,
recording the auditory message in real time to allow re-using the recorded auditory message in deferred time,
transforming the auditory sensory message into a visual message,
projecting the visual message, following a user command, on a screen integral with the support of the spectacle or equivalent component placed in the field of vision of the user,
carrying out the command by at least one pupil movement of the user, and
performing the projection of the visual message in a static or scrolling way, one single time or repeatedly, immediately or with a delay, depending on the user command that is picked up by a member detecting the pupil movement.

17. The method for helping the hearing-impaired person according to claim 16, further comprising carrying the projection of the visual message out on at least two display lines, with the first line being assigned to the display of the visual transcription of the auditory message, and the second line being assigned to additional information useful for the comprehension of the message.

18. The method for helping the hearing-impaired person according to claim 17, further comprising translation the additional information, useful for the comprehension of the message, into a language selected by the user.

19. The method for helping the hearing-impaired person according to claim 17, further comprising carrying out the projection of the visual message with a predetermined lag with respect to communication of the auditory message.

20. A device (10) implementing the method for helping a hearing-impaired person called a user to understand an auditory sensory message, the device including means for transforming the auditory sensory message into a visual message and means for projecting the visual message on a surface positioned in a field of vision of the user, wherein the device comprises:
a support (11) arranged to carry the set of functional elements involved in the fulfillment of the functions of the method, the set of functional elements comprising:
at least one sensor (16, 17) mounted on the support and arranged to pick up the auditory sensory message,
recording and memorizing means (19a, 19′a) for recording and memorizing the auditory message in real time,
transformation means (19b, 19′b) for transforming the auditory sensory message into a visual message,
a screen (18) integral with the support (11) and placed in the field of vision of the user,
at least one element (20, 21) for projecting the visual message on the screen of the support,
at least one sensor (25, 26) for sensing pupil movement of the user,
means (19c, 19′c) for converting the pupil movement of the user into a display command for the visual message, and
means (19d, 19′d) for carrying out the command by projecting the visual message in a static or a scrolling way, one single time or repeatedly, immediately or with a delay.

21. The device according to claim 20, wherein the support is of a spectacle or equivalent component and comprises a front bar (12) with a bridge (13), and the front bar carrying two temples (14, 15) articulated at the ends of the front bar (12).

22. The device according to claim 21, wherein the at least one element to project the visual message includes two projectors (20, 21) respectively mounted on the temples (14, 15), each of the projectors is arranged so as to project at least a part of the visual message corresponding to the auditory sensory message.

23. The device according to claim 20, wherein the device comprises means (25, 26) for picking up at least one pupil movement of the user, means for interpreting the at least one pupil movement and means for carrying out a command for projecting the visual message according to the interpretation of the pupil movement.

24. The device according to claim 22, wherein the means (19d, 19′d) for carrying out a command for projecting the visual message is coupled with the two projectors (20, 21) arranged to project at least a part of the visual message.

25. The device according to claim 20, wherein the at least one sensor arranged, for picking up the auditory sensory message, is a directional microphone (20, 21) mounted on the front section of the support.

26. The device according to claim 20, wherein the device includes an electronic unit (19) powered by an electrical power source (22), the electronic circuit comprising a first memorization module (19a) arranged to memorize temporarily and in real time the auditory sensory message, a second transcription module (19b) arranged to transcribe the auditory message into visual data, a third control module (19c) arranged for receiving and interpreting the pupillary command message and working out the corresponding visual message, and a fourth display triggering module (19d) arranged for carrying out the display of the message according to the pupillary command.

27. The device according to claim 26, wherein at least one of the first memorization module (19a), the second transcription module (19b), the third control module (19c) and the fourth display triggering module (19d) of the electronic circuit (19) is arranged remotely from the support of device (10) and comprises means (30, 31) for transmitting and receiving information to and from a device-external equipment.

28. The device according to claim 21, wherein the device comprises a display device (18) mounted on the front bar arranged for displaying the visual message in the form of a signal made of at least one of words, written phrases and informative acronyms.

29. The device according to claim 26, wherein the display device comprises a screen (18) including at least two lines (18a, 18b) arranged for displaying the visual message in a static or scrolling way, one single time or repeatedly, immediately or with a delay.

30. The device according to claim 26, wherein the device is connectable, through the electronic unit (19), with any external device having a suitable connection for receiving an auditory signal to be processed is a similar way and procedure as a signal provided by microphones (16, 17).

31. The device according to claim 30, wherein the device is connectable through a “Bluetooth” transceiver type electronic unit (19).
